(19) United States
(12) Patent Application Publication
(10) Pub. No.: US 2006/0116880 A1
(43) Pub. Date: Jun. 1, 2006

(54) Voice-driven user interface

(76) Inventor: Thomas Gober, Glen Allen, VA (US)

Correspondence Address: W. EDWARD RAMAGE, COMMERCE CENTER SUITE 1000, 211 COMMERCE ST, NASHVILLE, TN, 37201, US

(21) Appl. No.: 11/219,958

(22) Filed: Sep. 6, 2005

Related U.S. Application Data
(60) Provisional application No. 60/607,287, filed on Sep. 3, 2004.

(51) Int. Cl. G10L 21/00

(52) U.S. Cl. 704/270

(57) ABSTRACT

A system for a user to give vocal commands and input and receive aural or visual feedback through a headset or other means that telecommunicates with an interface program module installed on or connected to a computer or similar device. The vocal input is converted into digital signals compatible with a particular end-user application program, which receives the signals and takes action thereon. One or more templates may be used to solicit input from the user in a structured manner.

This application claims benefit of the previously filed Provisional Patent Application No. 60/607,287, filed Sep. 3, 2004, by Thomas Gober, and is entitled to that filing date for priority.

### FIELD OF INVENTION

This invention relates to a system for a voice-driven user interface. More particularly, the present invention relates to a system for a user to give vocal commands and receive aural feedback through a headset or other means that telecommunicates with an interface program module installed on or connected to a computer or machine with a microprocessor. The interface program module interacts with a variety of end-user programs.

### BACKGROUND OF INVENTION

Voice recognition software and systems are known in the industry, but suffer many problems with their use and application. Most require a long learning curve in order for the program to recognize the speaking style and intonations of a particular user, and require extensive input from the user in order to develop a sufficient vocabulary database. Even after a substantial investment of time, voice recognition software often makes numerous transcription errors. These and several other problems in the current voice driven software programs add to the difficulty for general use of these programs.

An additional problem is that the voice recognition software and related hardware typically requires the user to be at or near the computer being used in connection with the software and hardware. This often requires the user to sit in front of the computer where he or she can view the computer screen. This operational requirement severely limits the productivity of the user and the general applicability of voice technology software for popular use.

In addition, computer software often is limited in scope and use. The known common software application is for limited word processing functions.

Thus, what is needed is a voice-driven user interface that a user can use away from the computer for a variety of applications and settings beyond basic word processing.

### SUMMARY OF THE INVENTION

The present invention relates to a system for a user to give vocal commands and receive aural feedback through a headset or other means that telecommunicates with an interface program module installed on or connected to a computer or machine with a microprocessor. The interface program module interacts with a variety of end-user programs, such as, but not limited to, MS Word, Excel, Access, PowerPoint, and the like. These software applications do not need to be modified or reprogrammed, but accepts input via the subject invention.

In one exemplary embodiment, a headset or other wireless communication device is used to give vocal commands to the interface program module, which may be either internal or external to a computer system. The interface program module then communicates with chosen end-task applications. The communication may be accomplished through cable, Ethernet connection, wireless, or other means. Communications can be secure and/or encrypted. The interface program module converts the vocal commands given by the user into input commands recognized by the software application.

### DESCRIPTION OF THE DRAWINGS

FIG. 1 shows a schematic diagram of one embodiment of the present invention.

FIG. 2 shows a schematic diagram of an interface system template in accordance with one embodiment of the present invention.

### DESCRIPTION OF THE INVENTION

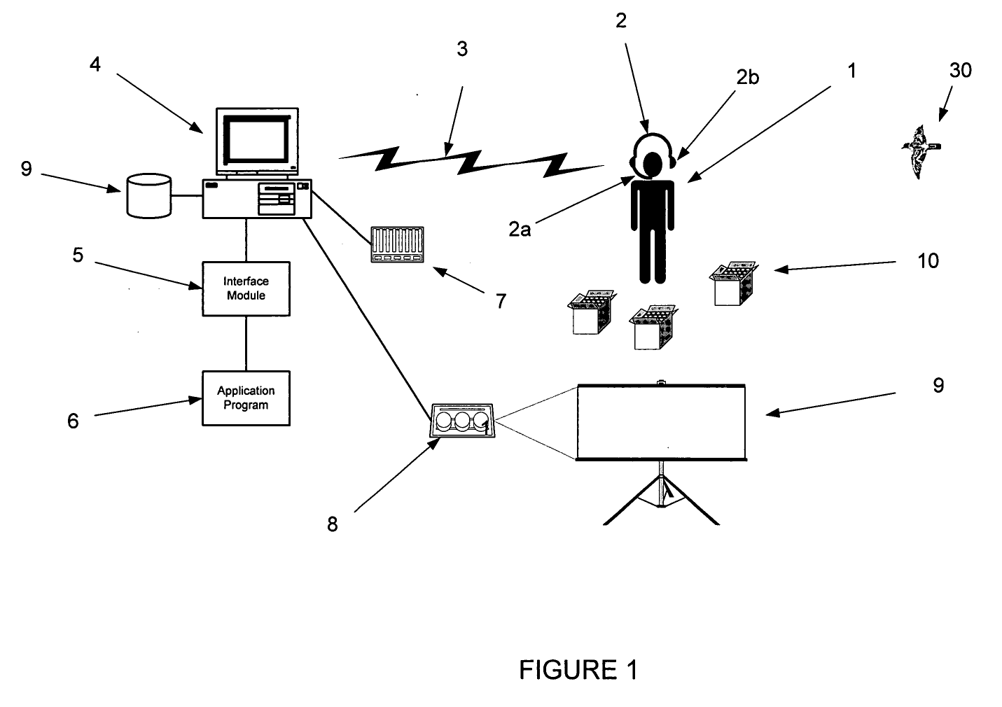

The present invention provides for a voice-driven user interface that allows a user to use voice commands to perform tasks, or a series of tasks, through a variety of end software applications using standard software configurations. In one exemplary embodiment, as shown in FIG. 1, the user 1 uses a headset 2 with an attached microphone 2a or other voice-transmission device, such as a standalone microphone, to give voice commands which are transmitted via wires or wirelessly 3 to an interface program module 5 residing on a computer 4 or device equipped with a microprocessor. The interface program module then interfaces with the chosen end software application 6 by converting the vocal commands into appropriate inputs for that application 6. Communication can be through an appropriate cable or Ethernet connection, wirelessly (such as, but not limited to, Bluetooth), or other means 3. Communications may be secure and/or encrypted.

End software applications include, but are not limited to, any commonly-used and accepted software application, such as MS Word, Excel, Access, PowerPoint, Internet Explorer, and the like. The end software application does not need to be modified or reprogrammed, as the conversion of vocal commands given by the user to input and commands recognized by the end software is handled by the interface program module 5.

In one exemplary embodiment, the interface program module 5 contains a vocabulary of command words and phrases. A particular word or phrase used as a vocal command can be associated with a series or sequence of commands or words or input for a particular application 6, and the giving of that vocal command can cause that sequence to be executed or inputted. In one embodiment, the vocabulary database is restricted in size, so the amount of education and “training” that is needed for voice recognition is minimized. The meaning of a particular vocal command may be the same or may vary for different applications 6.

Feedback can be given to the user in a variety of ways, visually and aurally. Thus, for example, the user can received aural feedback through the speakers 2b on a headset 2 or a standard set of speakers 7, repeating vocal commands that have been given, reporting the status or result of a process or command sequence (e.g., “Command Executed”), or prompting the user for additional input if needed or desired. While the user may view a monitor attached to the computer for visual feedback, a projection unit 8 may be used to project the display on a large screen 9, wall, or similar object, whereby the user can receive visual feedback without being at the computer.

In one exemplary embodiment, the interface program module 5 may incorporate a speech recognition engine. Alternatively, the interface program module 5 may interface with currently available speech recognition engines, including but not limited to Dragon Naturally Speaking and Via Voice.

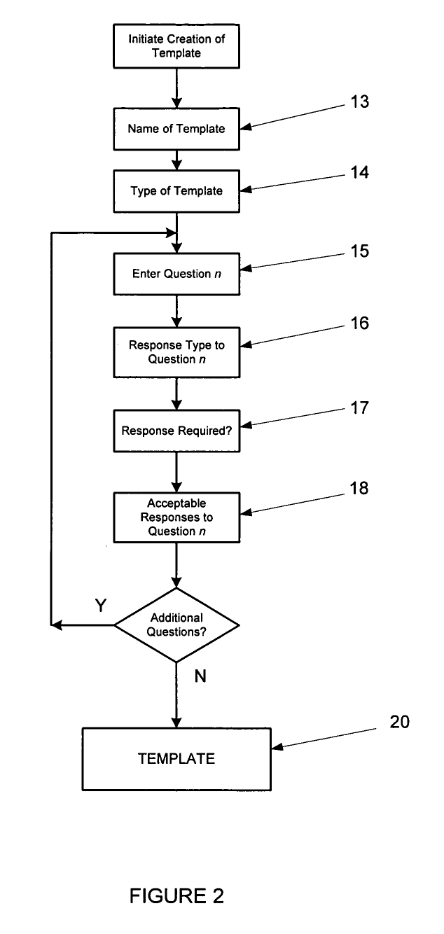

In one exemplary embodiment, input from the user is solicited through templates 20. Templates 20 may be pre-constructed for use with particular applications, or may be created by the user, as shown in FIG. 2. Templates created by the user may be saved; accordingly, a particular template need only be created once.

In an exemplary embodiment, a user creates a template 20 by initiating a template creation process 12. The user is prompted to enter certain information, including but not limited to, (a) the name of the template 13, (b) the type of the template (or the group that it belongs to) 14, (c) the question(s) to be asked by the interface control module when the template is used 15, (d) the type of data expected in response to the question asked 16, and (e) whether a response to the question is required 17. The template also may be created so as to incorporate a “value list” 18 of acceptable responses that are considered valid for a particular question. The use of a value list may thus limit acceptable verbal responses to a few options, significantly improving recognition accuracy.

In another exemplary embodiment, the question to be asked can be input as a typed question during template creation, which will then be converted to digitized speech asking the question when the template is run, or the question may be recorded by the user as a spoken phrase that is digitally stored and played back when the template is run, thus providing a more human aspect to the interface.

In another exemplary embodiment, all data handled or used by the interface program module 5, including any vocabulary data, is stored in a database 9. The database 9 may be a simple flat-file database, or a relational database.

The use of the present invention is further illustrated by the following, non-exclusive examples.

### EXAMPLE 1

A golf course superintendent equipped with the present invention could monitor and adjust his or her nitrogen mix in the fertilizing process, while at the same time, on a real-time basis, have knowledge and receive warnings where the nearest lightning threats are, as well as the locations of golfers. Exemplary commands needed by the superintendent are as follows: “Open FertilizerCalc, local NOAA weather and MemberFind”. This command would “maximize” the already running end software programs covering fertilization management, weather reports, and the location of golfers on the course. The superintendent could then followup by saying “Increase nitrogen by 0.1 grams/liter for 14 days, advise nearest lightning threat, and find Sammy Jones”. The superintendent would then receive feedback through the headset, such as “Command executed. Lightning strike 3.5 miles northwest. Jones 95 yards from 14th pin.”

### EXAMPLE 2

An accountant or attorney equipped with the present invention could inspect, review, tag and enter notes regarding a large number of documents. While reviewing a box of documents 10, the accountant or attorney could enter vocal commands and information about critical or important documents as they are seen, including information about the substance of the document and its location. The transcription can be projected onto a wall in the document production room, so the user does not have to be at the computer while reviewing the documents. Thus, for example, the user can enter domain specific settings for the rows and columns, such as “John S”=“Jonathan S Smith”. The data can then be defined for the remaining columns in the spreadsheet and one-word vocalizations can then be confirmed aurally and visually. The remaining data can then be assigned to each cell in the program that was pre-defined by the voice software. Thus, this software aids the streamlining and efficient data collection to increases productivity and frees time for the professional to complete additional tasks.

The present invention is useful in any application where the user cannot direct his or her attention to a computer screen, is required to move around, or is required to operate with his or hands free. Further non-exclusive examples of users benefiting from such applications include pilots, musicians, entymologists, archaelogists, farmers, air traffic control, homeowners, and pet owners. For example, if a collared pet gets within a certain distance of a pet door or doorway to the outside, the homeowner working several rooms away can be aurally told via headset that “Spot Wants Out. Respond please.” The homeowner can then give the desired vocal command (e.g., “yes” or “no”).

Another commercial use of this invention could be found in the auto industry. The voice-activated software could be used in conjunction with an Excel based spreadsheet. The domain specific definitions could be set for such categories as make, model, number of doors, color and engine size, and lot numbers. The voice-activated software could then verbally prompt the manager (who may move freely throughout the car lot) during the inventory task to speak all the information as input. These data cells would be simultaneously entered into the appropriate Excel columns as previously defined.

The present invention also could be used in conjunction with current television technology. A consumer could purchase a TV with the voice interface installed. The owner would then program the domain specific channels for menus with classifications of channel genres. For example, “sports” vocalized by a user would pull up several different channels such as ESPN and ESPN 2 and ESPN Classic. The user would then verbally choose one of these channels.

Entities that have alternative vocalizations with consistent meanings also can use the present invention. For example, an autistic child that has a consistent pattern of vocalizations (but otherwise limited speech and vocabulary) with an understood meaning could program domain specifications into the interface software. These responses could then be converted to aural specific words.

The present invention also may have application in non-human research, such as studies in both the primate and marine environments. Enhancements beyond sign language with primates could become a possibility since there is a consistent pattern of vocalizations within the primate sub-divisions. Dolphins, porpoises and the like similarly have consistent alternative patterns of communication.

In another exemplary embodiment, a user may operate a pre-established or previously created template 20 to access one or more databases 9 containing information about a topic of interest. In one alternative configuration, as seen in FIG. 31 the user 1 could identify a particular object or item or condition through a series of questions posted by the interface to the user by means of the template. A bird enthusiast or ornithologist, for example, upon spotting a bird of unknown specie 30, could initiate the program interface by saying “What type of bird?” or alternatively, “Activate template, identify bird” into the headset, which would cause the interface to initiate the bird identification template and establish a connection o the database. The interface would then ask the user a series of questions in order, such as “Primary color?” As the user responds with an appropriate answer (e.g., “blue”) to each question, the interface would proceed down the decision-tree-like series of questions (as determined by the template) until the final determination of specie is made.

The same method would apply to other types of objects or conditions the user is attempting to identify, including, but not limited to, flowers, snakes, trees, insects, planes, automobiles, mechanical conditions, medical diagnoses, building inspection, and the like. Each type of object or condition would have a pre-determined template with questions to be posed to the user. The template questions and structure would be designed to best suit the category of object(s) being identified. The template would be activated verbally, pose questions verbally, and receive responses verbally.

The availability of a wireless headset, linked to a nearby computing device, such as a laptop or handheld PocketPC, means that the user need not leave the location of observation to access a stack of books at a library, sit at a computer somewhere and conduct an Internet search, or even use their hands. This method of learning and exploring and identifying new items and objects would be particularly appealing in the field of education. Students would not only have an enjoyable means of identifying objects, but would learn an identification methodology useful for particular categories (including the important questions for that particular field). The student gains knowledge of the classification process and the application of the scientific method.

Thus, it should be understood that the embodiments and examples have been chosen and described in order to best illustrate the principals of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art. Accordingly, it is intended that the scope of the invention be defined by the claims appended hereto.

I claim:

1. A system for giving and receiving vocal input and output, comprising:
a. means for voice transmission;
b. an interface program module for receiving the voice transmission and providing input to a computer-based application program based on the voice transmission.

2. The system of claim 1, wherein the voice transmission contains a combination of vocal commands and vocal input.

3. The system of claim 1, wherein the means for voice transmission comprises a microphone.

4. The system of claim 3, wherein the microphone is attached to a headset.

5. The system of claim 3, wherein the microphone is attached to an article of clothing on the user.

6. The system of claim 1, wherein the voice transmission is sent to the interface program module by one or more communications wires.

7. The system of claim 1, wherein the voice transmission is sent to the interface program module by wireless means.

8. The system of claim 1, wherein the voice transmission is encrypted or secured.

9. The system of claim 1, further comprising:
a. means for receiving feedback from the computer-based application program.

10. The system of claim 9, wherein the means for receiving feedback comprises a computer monitor.

11. The system of claim 9, wherein the means for receiving feedback comprises a combination of a projection device for projecting an image and a means for displaying the projected image.

12. The system of claim 9, wherein the means for receiving feedback comprises one or more speakers providing audible feedback.

13. The system of claim 9, wherein the means for receiving feedback comprises headphones providing audible feedback.

14. The system of claim 13, wherein the headphones are combined with a microphone in a headset device.

15. The system of claim 1, further comprising one or more interface templates.

16. The system of claim 15, wherein the interface template is adapted to solicit voice input from a user.

17. The system of claim 15, where one or more of the interface templates are created by the user.

18. The system of claim 16, wherein the interface template tests the voice input for valid responses to questions posed by the interface template.

19. The system of claim 15, wherein the interface template communicates with a database.

20. The system of claim 1, wherein the interface program module interfaces with or contains a speech recognition engine.

21. A method for giving and receiving vocal input and output, comprising following steps:
a. speaking words into voice transmission means;
b. transmitting the spoken words to an interface program module;
c. converting the spoken words into digital signals compatible with a particular computer-based application program; and
d. transmitting the digital signals to the computer-based application program.

21. The method of claim 20, wherein the voice transmission means is a microphone.

22. The method of claim 20, wherein the transmission to the interface program module is by wireless transmission.

23. The method of claim 20, wherein the conversion of the spoken words into digital signals is by means of a speech recognition engine.

24. The method of claim 20, further comprising:
a. providing feedback from the computer-based application program.

25. The method of claim 24, wherein the feedback is audible and provided through headphones.

26. The method of claim 25, wherein the headphones are combined with a microphone in a headset.

27. The method of claim 20, wherein the speaking of words into the voice transmission means is solicited through one or more templates.

28. The method of claim 27, wherein the template poses a series of questions to a user.

29. The method of claim 28, wherein the sequence of questions posed is determined by the template, and may vary depending on the responses to earlier questions in the sequence.

30. The method of claim 29, wherein the responses provided by user are compared to information contained in a database to determine the identity of an object or item.
